(19) United States
(12) Patent Application Publication
(10) Pub. No.: US 2008/0314996 A1
(43) Pub. Date: Dec. 25, 2008

(54) Value Card PIN Security Method and Device

(76) Inventor: Chandilyn Smith, Atlanta, GA (US)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 11/765,020

(22) Filed: Jun. 19, 2007

(51) Int. Cl. G06K 19/06; B42D 15/00

(52) U.S. Cl. 235/494; 283/101

(57) ABSTRACT

A value card comprising a substantially planar substrate with first indicia applied to a surface of the substrate is provided. An obscuring layer formed from an opaque material is disposed over the first indicia so as to prevent at least a portion of the first indicia from being viewed. The obscuring layer is configured so that the opaque material can be removed to reveal the at least a portion of the first indicia but cannot be reapplied over the first indicia. The value card further comprises a security device comprising second indicia comprising a predetermined pattern. At least a portion of the second indicia is formed on the obscuring layer so that removal of the opaque material to reveal the at least a portion of the first indicia also removes the at least a portion of the second indicia.

### BACKGROUND

Gift and phone transaction cards are available for sale at almost every retailer throughout the world. These cards have been successful, in part, because they enable users to purchase goods and services in a manner that does not require cash on hand or establishing a pre-existing account. Security for these cards is achieved through use of a personal identification number (PIN), which is printed on the card surface and concealed beneath a scratch-off label. Users purchase the card, remove a portion of the scratch-off label to reveal the PIN, then activate the card using a control number and the PIN. The control number is also printed on the card surface in a manner readily observable by users.

As transaction cards have increased in popularity, incidents of card misuse have increased as well. One method of misuse involves removing just enough of the scratch-off label to reveal the PIN, then covering the damaged area with an appropriately colored material or ink. With the PIN and control number in hand, the cards value can be extracted without actual physical possession of the card. An unsuspecting purchaser, without careful scrutiny, may buy the card only to discover that the security of the card has been breached. Alternatively, the retailer may observe the damage to the card. By the time the retailer or purchaser discovers the damage, however, the misuse will have likely occurred.

Accordingly, there is a need for a device that can readily indicate whether a transaction card has been subject to misuse.

### SUMMARY OF THE INVENTION

An aspect of the invention provides a value card comprising a substantially planar substrate with first indicia applied to a surface of the substrate. An obscuring layer formed from an opaque material is disposed over the first indicia so as to prevent at least a portion of the first indicia from being viewed. The obscuring layer is configured so that the opaque material can be removed to reveal the at least a portion of the first indicia but cannot be reapplied over the first indicia. The value card further comprises a security device comprising second indicia comprising a predetermined pattern. At least a portion of the second indicia is formed on the obscuring layer so that removal of the opaque material to reveal the at least a portion of the first indicia also removes the at least a portion of the second indicia.

### BRIEF DESCRIPTION OF THE DRAWINGS

The accompanying figures depict certain illustrative embodiments and may aid in understanding the following detailed description. The embodiments depicted are to be understood as exemplary and in no way limiting of the overall scope of the invention. The detailed description will make reference to the following figures, in which:

FIG. 1 illustrates the front side of a value card in accordance with an exemplary embodiment.

FIG. 2A illustrates the back side of a value card in accordance with an exemplary embodiment wherein the security feature is intact.

FIG. 2B illustrates the back side of a value card in accordance with an exemplary embodiment wherein the security feature has been breached.

FIG. 3 is a flow chart illustrating a process flow for forming a value card in accordance with an exemplary implementation.

FIG. 4 illustrates an example network in which embodiments of the present system, method and device may be practiced.

Throughout the drawings, like reference numbers refer to like elements, features, and structures.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions or well-known functions and constructions are omitted for clarity and conciseness.

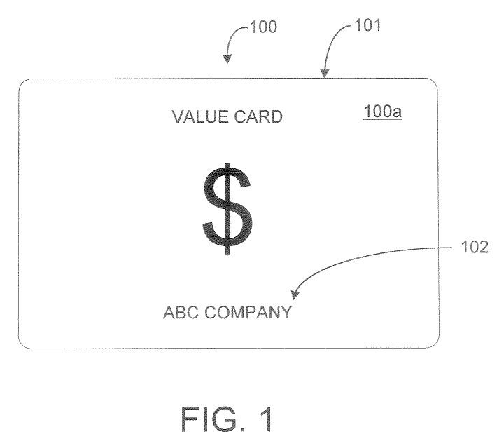

FIG. 1 illustrates the front side of a value card in accordance with an exemplary embodiment. Value cards comprise transaction cards such as gift cards, phone cards, and debit cards. This specification discloses exemplary embodiments through the example application of a value card. The security device disclosed herein, however, is not limited in its application to value cards and can be applied to any material placed over indicia requiring security so that when tampering occurs, visual indication of the tampering is evident.

With respect to a value card, the value card may comprise any physical shape and configuration, and also may comprise any type of material. In some exemplary embodiments, the value card may be configured in a manner similar to a standard credit or debit card, made of plastic and having the same or similar proportions and features. In some exemplary embodiments, the value card may be card-like, but have proportions different from a standard credit or debit card, for example, a keychain card, a folding paper card, a metal card, and so forth. In addition, the value card may be non-card-like, for example, a key fob, miniature figure, and/or a communication device, etc. In some exemplary embodiments, the value card may be available in multiple configurations allowing a user to select his or her desired configuration. For example, the value card may be available in a standard credit card-sized card and/or a smaller keychain card and/or a key fob.

In exemplary embodiments the value card may include electronic and or magnetic features, for example, a microprocessor, memory, an electronic chip, a magnetic strip, a Universal Serial Bus (USB) flash drive, a wireless communication device, etc. For example, a value card may have the same or similar features to a credit or debit card, such as having a magnetic strip located on the back of the card, and thus may be compatible with standard credit card readers. The value card may also be configured in a manner similar to a “smart card.” Memory on the value card may be configured to store information related to a user, third party, processor, and/or past transactions, as well as other types of information related to the value card. In some exemplary embodiments, the value card may be configured to communicate with a wired device, such as by USB, coaxial cable, etc., and or a wireless device, such as by using Bluetooth® and/or radio frequency identification (RFID) technology, etc.

The value card may have identification indicia, such as, by way of example, alpha characters, numeric characters, alphanumeric characters, images, embossed numbers, a coded magnetic strip, an embedded electronic chip, bar codes, and/or other such identification indicia as known in the art. In some exemplary embodiments, there may be unique identification indicia for each value card. Alternatively, some or all of the value cards may include the same identification indicia, or there may be a group of value cards with the same identification indicia within the group, but with a different indicia from other groups.

The identification indicia may be configured to associate the value card with a user, a third party, a processor, a retailer, and/or some other entity. The association may be accomplished by memory located remote of the value card or may be located on the value card itself. For example, information about the value card and/or the user may be stored in a remote database and/or may be embedded in a magnetic stripe on the value card. In addition, the value card may be associated with a particular third party using indicia that is visible on the card, such as, by way of example, a biller-specific telephone number and/or trademark.

As seen in FIG. 1, a value card 100 includes a substrate 101 having a front side 100a upon which is optionally printed identifying information 102, illustrated here, by way of example, as “ABC Company.” The substrate 101 can be formed of cardboard, paper or plastic, and generally has the rectangular shape and size of a credit-card. Substrate 101, however, can be formed of any material capable of receiving a first indicia, such as, for example, a personal identification number (PIN), printed or deposited thereon and is unlimited as to shape and size. For example, the value card can be formed of a stainless steel substrate in the shape of a disc substantially the size of a U.S. silver dollar.

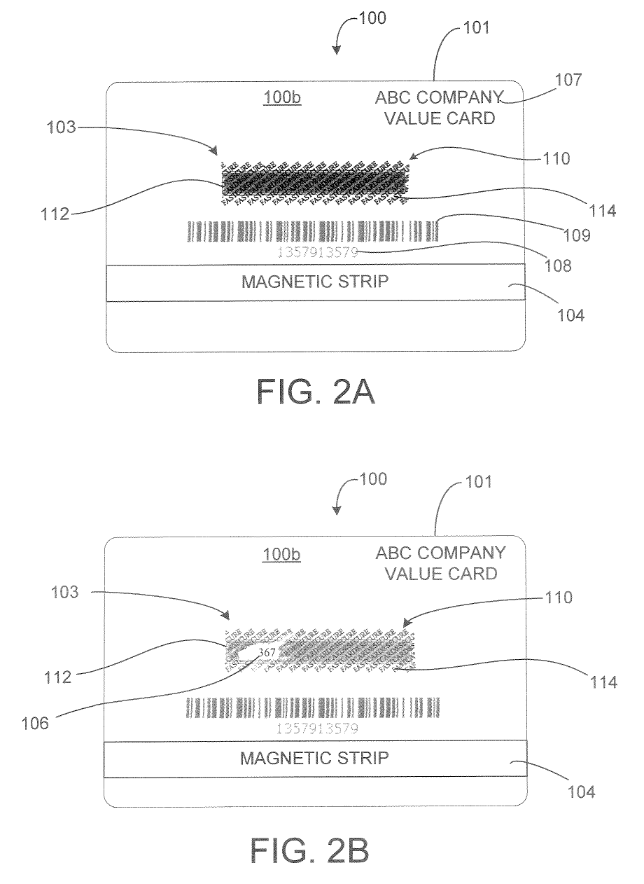

FIGS. 2A and 2B each illustrate the back side 100b of the value card 100. The back side 100b has an indicia area 103 upon which a first set of indicia 106 may be applied. The first set of indicia may be applied directly or the indicia area 103 such as by printing or may be applied via a carrier layer adhered to the substrate 101. The first indicia 106 includes information such as a Personal identification number (PIN) or a card-specific control number that is to be concealed until a particular event (e.g., activation or sale of the card to a user) has occurred. Toward that end, a removable obscuring layer 112 is applied over the first indicia 106. The obscuring layer 112 is an opaque layer of material that can be readily removed, but is destroyed or visibly and irreparably damaged upon removal. The obscuring layer 112 may include but is not limited to ink, ink with clear coating, “scratch-off” or “rub-off” materials and adhesive strips. The obscuring layer 112 can be affixed or applied using materials and methods known to those of ordinary skill in the art, such as, for example, spray of ink, hot foil stamp, wax or sticker. The obscuring layer 112 is positioned so as to conceal some or all of the first indica 106.

The obscuring layer 112 may be applied directly to the indicia area 109 of the substrate 101 over the top of the first indicia. In embodiments where the first indicia 106 is applied to a carrier layer, the obscuring layer may be applied to the carrier layer over the top of the first indicia.

The card 100 also includes a security device 110 that is configured to reveal attempts to remove some or all of the obscuring layer 112. The security device 110 may include a second set of indicia 114 formed on, overprinted on, or in the obscuring layer 112 and, in some embodiments, on or in the surface of the back side 100b surrounding the obscuring layer 112. The second indicia 114 may be any uniform or non-uniform pattern of characters or figures that would be difficult to replicate. This may include, for example, alphanumeric text positioned periodically or randomly across the obscuring layer 112. Alternatively, the second indicia 114 can comprise an image, graphic symbol or geometric figure. In an exemplary embodiment, the pattern of the second indicia 114 may be varied from card to card or between groups of cards.

FIG. 2A illustrates the card 100 in a first condition in which the security device 110 and the obscuring layer 112 are intact. FIG. 2B illustrates the card 100 in a second condition in which a portion of the obscuring layer 112, has been removed revealing a portion of the first indicia 106. By removing some or all of the obscuring layer 112, damage to the security device 110 is readily observable. Thus, retailers and prospective purchasers can immediately observe that the security of the value card 100 has been breached.

The second indicia 114 may be applied in a visible or non-visible print medium such as ink or varnish. The print medium may be selected for compatibility with the material of the obscuring layer 112 and/or desired bleed-through characteristics. In exemplary embodiments the print medium may be or include an ultraviolet or infrared ink. In exemplary embodiments the print medium may comprise a solvent coating, which includes ink with solvents such as water or other materials. The print medium may be applied to the obscuring layer 112 at the time of or after the obscuring layer 112 has been applied to the substrate 101. In embodiments where the first indicia 106 and the obscuring layer 114 are applied to a carrier layer, the print medium may be applied before or after the carrier layer is adhered to the substrate 101.

As an alternative to printing, the second indicia 114 may be formed by surface contour variations such as may be produced by mechanical embossing or debossing or laser removal of material. This may be accomplished after the obscuring layer 112 has been applied to the substrate 101. In embodiments where the first indicia 106 and the obscuring aver 114 are applied to a carrier layer, the surface contour variations may be established before or after the carrier layer is adhered to the substrate 101.

The security device 110 may include an appliqué that is placed atop the obscuring layer 112, the appliqué carrying the second indicia 114. Such an appliqué can be applied to the obscuring layer 112 via an adhesive material so that the appliqué cannot be removed without at least partial destruction.

In particular embodiments, the second indicia 114 may be configured so that it extends beyond the boundary of the obscuring layer 112 and onto or into the surface of the substrate 101. In such embodiments, the form or medium of the second indicia may be such as to make removal of the second indicia 114 from the substrate 101 difficult or impossible. This serves to make replication of the security more difficult because attempt to replace or replicate the obscuring layer 112 and the security device 110 would require that the pattern of the replicated second indica 114 match up with the permanent second indicia 114 printed on the substrate 101. Any discrepancy will be highlighted by the fact that the second indicia are formed on two distinct surfaces that may have two distinct backgrounds and textures.

As shown in FIGS. 2A and 2B the card 100 may a also have identifying information 107, a magnetic strip 104 and a control number 108 with an associated bar code 109. Both the optional magnetic strip 104 and bar code 109 are machine readable and can contain information about the card 100, such as issuing company, initial value, issuing region, applicable uses, duration of activation, etc.

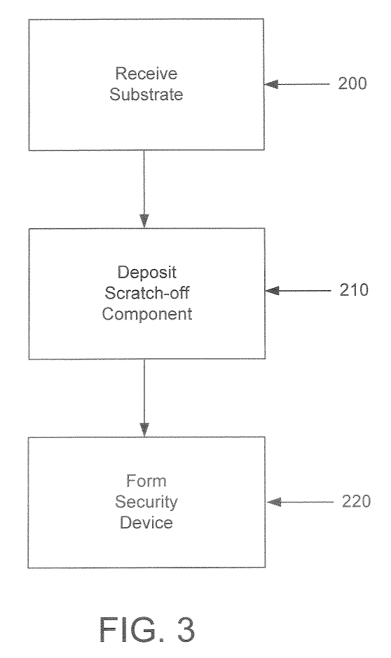

FIG. 3 is a flow chart illustrating a process flow for forming a value card in accordance with an exemplary implementation. To form a value card 100, a substrate 101 having first indicia 106 deposited on the indicia area 103 thereof is received at 200. The first indicia 106 may be, for example such as, for example, a PIN. An opaque obscuring layer 112 is deposited on the substrate 101 so that some or all of the first indicia 106 is concealed at 210. A security device 110 is formed on or with and, in some embodiments, at the same time as the obscuring layer 112 at 220. The substrate 101, obscuring layer 112, and security device 110 may be as described above with respect to FIGS. 2A and 2B. The security device 110 comprises second indicia 114 that is damaged or removed when the obscuring layer 112 is removed to reveal the first indicia 106. The second indicia 112 may include a pattern that is difficult to replicate. In particular embodiments, the second indicia is formed so that a first portion is formed on the obscuring layer 112 and a second portion is formed on the substrate 101 adjacent the obscuring layer. The first and second portions of the second indicia may be formed so that the pattern extends uninterrupted across the perimeter of the obscuring layer 112. In a particular embodiment, the first and second portions are formed in a single operation.

As discussed above, the second indicia may be formed in a printing media, in which case the action of forming the second indicia includes printing, overprinting, or otherwise applying the printing media to form the second indicia. The second indicia may alternatively be formed by establishing surface contour variations in the obscuring layer and, in some cases, the substrate. In these instances, the action of forming the second indicia may include embossing, debossing or removing material such as by laser vaporization.

It will be understood that the actions described above need not be carried out in the order described. For example, the first indicia may be formed in initially on a carrier layer to which the obscuring layer and the security device are applied before the carrier layer is adhered to the substrate.

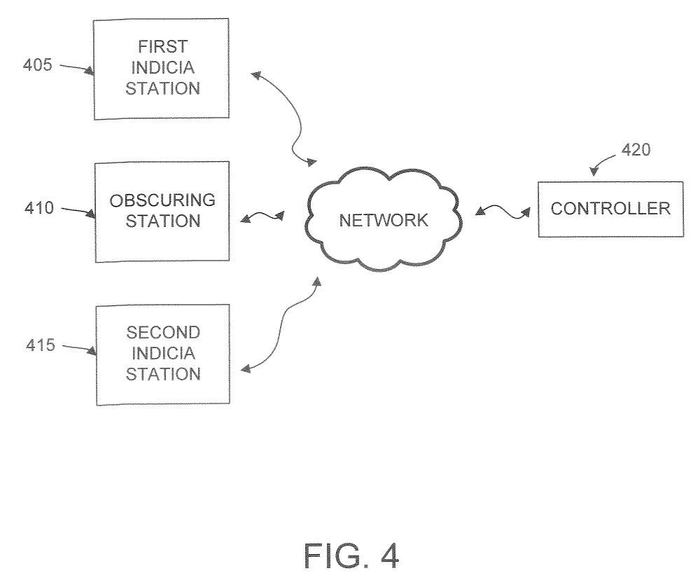

FIG. 4 illustrates an example production network in which embodiments of the present system, method and device may be practiced. In an exemplary embodiment, a production system 400 is provided that includes a first indicia station 405, where first indicia, such as a personal identification number (PIN), are applied to a substrate, such as by ink jet or other print means. The first indicia station 405 prints or deposits first indicia onto the surface of a substrate, such as planar card members, as the substrate advances along a path of travel. It is possible that the substrate could be printed with the first indicia off-line, or in another location, or in an in-line position.

After the first indicia is printed or deposited onto the surface of the substrate by the first indicia station 405, the substrate is advanced in a path of travel where, in one exemplary embodiment, a release coating is applied over the first indicia. The release of liquid or material coating is typically less than about 2 mil thickness and preferably about 0.0002 to about 0.0005 inches thick and could range up to about 0.002 inches. The release coating is preferably transparent, but does not have to be clear as it could be color tinted for aesthetic purposes. Typically, the release coating (if used) should be of a thickness and color such that the first indicia can be seen through the release coating.

An opaque obscuring coating is provided via an obscuring station 410 comprising a plate cylinder having impression plates in the form of print pads mounted thereon that engage a metering roll and transfers the release of obscuring material from the plate (pads) onto the surface of the substrate.

The release coating can be applied in a manner similar to that as any ink coating is applied in printing techniques, including flexographic techniques or ink. The release coating can, thus, be referred to as a printed ink coating that is applied onto the surface of the substrate over the first indicia and, in one exemplary embodiment, radiation/ultraviolet cured by an ultraviolet curing lamp. Although ultraviolet curing is a preferred method of curing, it is possible in some cases to use other types of radiation curing, including use of electron beam, blue light, laser and other radiation curing methods known to those of ordinary skill in the art.

A release coating need not always be employed depending on the type of substrate used. The amount of surface tension created by the substrate surface has an impact on the removability of the opaque obscuring coating layer. In an exemplary embodiment, the obscuring coating is formed as a silver ink, known to those of ordinary skill in the art, such that the obscuring layer could be removed without damaging the first indicia even without a release coating, in some instances. While in exemplary embodiments the obscuring coating can comprise a silver ink, the coating can be formed of any type of opaque ink known to those of ordinary skill in the art.

A second indicia station 415 can be used for applying a second coat of ink, obscuring coating material, or other printed indicia over the first obscuring coating. Naturally, the location of the second indicia station 415 could vary if it is employed to print a layer over the first indicia before application of the obscuring coating. In one exemplary implementation, the second indicia station 415 could comprise an ink jet print station and apply a fingerprint pattern or similar pattern that is opaque over (or under depending on position of the print station) the obscuring coating. The second indicia could be created by a plate cylinder or drum having impressions mounted thereon that engage a metering roll and transfers the release or obscuring material from the plate (pads) onto the surface of the substrate, or via a spray pattern of ink. In one exemplary embodiment, the obscuring coating comprises scratch-off material. The impression plates (print pads) can be formed of any type of material commonly known to those of ordinary skill in the art, including rubber print pads or photopolymer plates and/or other flexible plate or pad material, typically known and used by those of ordinary skill in the art. The second indicia station 415 could apply security indicia on the opaque obscuring coating that comprises a second indicia. Thus, if the obscuring coating and second indicia were removed, at least in part, and a label applied in its place, a purchaser would know that tampering has occurred because there would be no second indicia visible. That is, the second indicia would be damaged. The second indicia could be used for further security and correspond to control codes printed on the substrate. During application of a layer, coating, or indicia following application of the obscuring coating, a typical black ink can be provided, although other ink could be provided as known to those skilled in the art.

In exemplary implementations solvent coatings can be employed to convey indicia. Solvent coatings can comprise ink with solvents, such as water or other materials, which could be thermally dried. It is also possible to use coatings that comprise a two-part system for curing similar to epoxy. Other coatings could be used as known by those of ordinary skill in the art. Also, the substrate conveying mechanism could be any conveying mechanism, including drum, roller, plate, or other belt mechanism. A fingerprint pattern could be applied under or over the obscuring coating as noted above.

In exemplary embodiments a controller 420 is employed that could comprise a personal computer or other controller system known to those of ordinary skill in the art. The first indicia station, obscuring station 410, second indicia station 415, laser sensors, DC motor drives, servodrives (motors) encoders, shutter controls for the UV station, and any other motors and encoders used for a belt conveyor and other components of the system are all operatively coupled to the controller 420. The coupling could be through the network, such as the Internet, including a wired or wireless network.

In operation, a sensor senses the leading edge of an advancing substrate and registers this edge position to the controller 420. Throughout the substrate advancing process, the drive motors and encoder of the conveyor belt drive maintain accurate positional control over the substrate. The servodrive (motor) is operatively connected to each of the plate cylinders or drums and maintains rotational control to apply the release and obscuring coatings and indicia at a timed moment such that any coatings are applied at a specific location on the surface of the substrate.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims and equivalents thereof.

What is claimed is:

1. A value card, comprising:
a substantially planar substrate;
first indicia applied to a surface of the substrate;
an obscuring layer formed from an opaque material disposed over the first indicia so as to prevent at least a portion of the first indicia from being viewed, the obscuring layer being configured so that the opaque material can be removed to reveal the at least a portion of the first indicia but cannot be reapplied over the first indicia; and
a security device comprising second indicia comprising a predetermined pattern, at least a portion of the second indicia being formed on the obscuring layer so that removal of the opaque material to reveal the at least a portion of the first indicia also removes the at least a portion of the second indicia.

2. The value card of claim 1, wherein the first indicia is applied directly to the surface of the substrate.

3. The value card of claim 1, wherein the first indicia is formed on a carrier layer adhered to the substrate.

4. The value card of claim 1, wherein the second indicia comprises a plurality of alphanumeric characters.

5. The value card of claim 1, wherein the pattern comprises a periodically repeating sub-pattern.

6. The value card of claim 1, wherein the second indicia comprises a first indicia portion formed on the obscuring layer and a second indicia portion formed on the substrate surface adjacent the obscuring layer, the first and second indicia portions being configured so that the pattern extends uninterrupted over both the obscuring layer and the adjacent substrate surface.

7. The value card of claim 1, wherein the second indicia are formed as surface contour variations.

8. The value card of claim 1, wherein the second indicia varies between a plurality of value cards.

9. The value card of claim 1, wherein the opaque material is a scratch-off material.

10. A method of establishing a tamper evident security device on a value card, the method comprising:
applying first indicia to a surface of a card substrate;
applying an opaque material over at least a portion of the first indicia to form an obscuring layer, the obscuring layer being configured so that the opaque material can be removed to reveal the at least a portion of the first indicia but cannot be reapplied over the at least a portion of the first indicia; and
forming a security device comprising second indicia comprising a predetermined pattern, at least a portion of the second indicia being formed on the obscuring layer so that removal of the opaque material to reveal the at least a portion of the first indicia also removes the at least a portion of the second indicia.

11. The method of claim 10, wherein the first indicia is applied directly to the surface of the substrate.

12. The method of claim 10, wherein the first indicia is formed on a carrier layer adhered to the substrate.

13. The method of claim 10, wherein the second indicia comprises a plurality of alphanumeric characters.

14. The method of claim 10, wherein the pattern comprises a periodically repeating sub-pattern.

15. The method of claim 10, wherein the action of forming a security device comprises:
forming a first indicia portion on the obscuring layer and a second indicia portion on the substrate surface adjacent the obscuring layer, the first and second indicia portions being configured so that the pattern extends uninterrupted over both the obscuring layer and the adjacent substrate surface.

16. The method of claim 10, wherein the second indicia are formed as surface contour variations using one of the set consisting of embossing, debossing and material removal.

17. The method of claim 10, wherein the second indicia varies between a plurality of value cards.

18. The method of claim 10, wherein the opaque material is a scratch-off material.
